(19) United States
(12) Patent Application Publication
(10) Pub. No.: US 2025/0350738 A1
(43) Pub. Date: Nov. 13, 2025

(54) IMAGE PROCESSING METHOD AND SYSTEM, APPARATUS, AND STORAGE MEDIUM

(71) Applicant: SHANGHAI BILIBILI TECHNOLOGY CO., LTD., Shanghai (CN)

(72) Inventors: Yingfan ZHANG, Shanghai (CN); Tianxiao YE, Shanghai (CN)

(21) Appl. No.: 19/196,681

(22) Filed: May 1, 2025

(30) Foreign Application Priority Data
May 8, 2024 (CN) 202410565651.9

(51) Int. Cl. H04N 19/14; H04N 19/124; H04N 19/184; H04N 19/463; H04N 19/85

(52) U.S. Cl. CPC H04N 19/14; H04N 19/124; H04N 19/184; H04N 19/463; H04N 19/85

(57) ABSTRACT

The application discloses an image processing method. The method includes: performing a Lookahead precoding on an image to-be-processed, and obtaining a specified difference function resulting from the Lookahead precoding; determining an encoding complexity of the image based on the specified difference function, thereby dynamically configuring a maximum quantization group partition depth of the image; and formally encoding the image by using the maximum quantization group partition depth. The application further discloses an image processing system, an electronic apparatus, and a computer-readable storage medium.

### CROSS-REFERENCE TO RELATED APPLICATION

This application claims priority to Chinese Patent Application No. 202410565651.9 filed on May 8, 2024, which is incorporated herein by reference in its entirety.

### TECHNICAL FIELD

The application relates to the field of video coding technologies, and in particular, to an image processing method and system, an electronic apparatus, and a computer-readable storage medium.

### BACKGROUND

Current video coding standards are all developed based on a hybrid coding framework. In the framework, each frame in a video is first partitioned into fixed-size largest coding units (LCUs), and may be further partitioned into variable-size coding units (CUs). For each CU, a predicted image is first obtained by using an inter-frame or intra-frame prediction technology. A difference between the predicted image and a raw image, also referred to as a residual, is transformed and quantized, and then sent to an entropy encoder for encoding. Then the residual is inverse-quantized and inverse-transformed, and the predicted image is added for reconstruction. Finally, a reconstructed image is obtained through loop filtering. The reconstructed image enters an encoded (reconstructed) image buffer in the encoder as a reference image for inter-frame prediction in subsequent frame encoding.

In the foregoing hybrid coding process, quantization is a main source of video compression distortion. A magnitude of distortion is generally controlled by a quantization parameter (QP). The larger the QP, the greater the distortion. In the versatile video coding (VVC) standard, the QP is encoded by using a quantization group (QG) as a smallest unit. The QG is generally partitioned together with the CU, and a maximum QG partition depth is controlled by a parameter in an image header of each image, and must not be greater than a maximum CU partition depth. Currently, in reference software of the VVC standard and implementation of a mainstream encoder, a maximum QG partition depth is generally configured by using a global parameter, that is, a maximum QG partition depth of a video needs to be determined in advance before encoding of the video starts, and the value is uniformly used for encoding each frame of image of the video.

Although the foregoing global configuration method is widely used, because content of a video source is changeable, better compression performance cannot be achieved in all scenes. Even for videos in a same scene, complexity of a video coding process varies drastically under control of different parameters. Optimal encoding parameters corresponding to different encoding complexity are generally different. Clearly, the global configuration method cannot meet configuration requirements in these scenes.

### SUMMARY

A main objective of the application is to provide an image processing method and system, an electronic apparatus, and a computer-readable storage medium, so as to resolve a problem of how to dynamically configure a maximum QG partition depth.

To achieve the foregoing objective, an embodiment of the application provides an image processing method. The method includes:
performing a Lookahead precoding on an image to-be-processed, and obtaining a specified difference function resulting from the Lookahead precoding;
determining an encoding complexity of the image based on the specified difference function, thereby dynamically configuring a maximum quantization group partition depth of the image; and
formally encoding the image by using the maximum quantization group partition depth.

Optionally, the obtaining a specified difference function resulting from the precoding includes:
collecting an optimal SATD of each Lookahead unit obtained during the Lookahead precoding of the image; and
counting a sum of optimal SATDs of all Lookahead units in the image as the specified difference function.

Optionally, the determining an encoding complexity of the image based on the specified difference function, thereby dynamically configuring a maximum quantization group partition depth of the image includes:
setting two reference thresholds based on basic information and an empirical coefficient of the image, where a first reference threshold is less than a second reference threshold; and
determining the maximum quantization group partition depth of the image by comparing the specified difference function with the two reference thresholds.

Optionally, the setting two reference thresholds based on basic information and an empirical coefficient of the image includes:
counting an average quantization parameter of the image, and obtaining an image bit depth and an image size;
setting a first empirical coefficient and a second empirical coefficient, where the first empirical coefficient is less than the second empirical coefficient; and
setting the first reference threshold and the second reference threshold according to a preset formula, based on the first empirical coefficient, the second empirical coefficient, the average quantization parameter, the image bit depth, and the image size, where the first reference threshold is a product of a reference function multiplied by the first empirical coefficient, the second reference threshold is a product of the reference function multiplied by the second empirical coefficient, and the reference function is positively correlated with the average quantization parameter, the image bit depth, and the image size.

Optionally, the first reference threshold is: Threshold1=a1*2\hat{ }(avgQP/6−12+2*(BitDepth−8))*picSize; and
the second reference threshold is: Threshold2=a2*2\hat{ }(avgQP/6−12+2*(BitDepth−8))*picSize, where
a1 represents the first empirical coefficient, a2 represents the second empirical coefficient, avgQP represents the average quantization parameter, BitDepth represents the image bit depth, and picSize represents the image size.

Optionally, the determining the maximum quantization group partition depth of the image by comparing the specified difference function with the two reference thresholds includes:
when the specified difference function is less than the first reference threshold, setting the maximum quantization group partition depth of the image to 0.

Optionally, the determining the maximum quantization group partition depth of the image by comparing the specified difference function with the two reference thresholds further includes:
when the specified difference function is greater than or equal to the first reference threshold and less than the second reference threshold, setting the maximum quantization group partition depth of the image to 2.

Optionally, the determining the maximum quantization group partition depth of the image by comparing the specified difference function with the two reference thresholds further includes:
when the specified difference function is greater than or equal to the second reference threshold, setting the maximum quantization group partition depth of the image to 4.

Optionally, the determining the maximum quantization group partition depth of the image by comparing the specified difference function with the two reference thresholds further includes:
when the obtained maximum quantization group partition depth is greater than a preset maximum coding unit partition depth, modifying the maximum quantization group partition depth to the preset maximum coding unit partition depth.

In addition, to achieve the foregoing objective, an embodiment of the application further provides an image processing system. The system includes:
a precoding module, configured to perform a Lookahead precoding on an image to-be-processed, and obtain a specified difference function resulting from the Lookahead precoding;
a configuration module, configured to determine encoding complexity of the image based on the specified difference function, thereby dynamically configuring a maximum quantization group partition depth of the image; and
an encoding module, configured to formally encode the image by using the maximum quantization group partition depth.

To achieve the foregoing objective, an embodiment of the application further provides an electronic apparatus. The electronic apparatus includes a memory, a processor, and an image processing program stored in the memory and capable of running on the processor. When the image processing program is executed by the processor, the foregoing image processing method is implemented.

To achieve the foregoing objective, an embodiment of the application further provides a computer-readable storage medium. The computer-readable storage medium stores an image processing program. When the image processing program is executed by a processor, the foregoing image processing method is implemented.

To achieve the foregoing objective, an embodiment of the application further provides a computer program product. The computer program product includes an image processing program. When the image processing program is executed by a processor, the foregoing image processing method is implemented.

According to the image processing method and system, electronic apparatus, and computer-readable storage medium provided in the embodiments of the application, coding information generated in the Lookahead precoding process can be used as a basis for evaluating image encoding complexity, and a maximum quantization group partition depth of each frame of image is dynamically adjusted before the formal encoding starts, to adapt to different video content and encoding parameter conditions, thereby improving video compression efficiency without introducing additional computational overheads.

### BRIEF DESCRIPTION OF DRAWINGS

FIG. 1 is an architectural diagram of an application environment for implementing embodiments of the application;

FIG. 2 is a flowchart of an image processing method according to Embodiment 1 of the application;

FIG. 3 is a schematic diagram of a refined process of step S202 in FIG. 2;

FIG. 4 is a schematic diagram of a refined process of step S2020 in FIG. 3;

FIG. 5 is a schematic diagram of a hardware architecture of an electronic apparatus according to Embodiment 2 of the application; and

FIG. 6 is a schematic modular diagram of an image processing system according to Embodiment 3 of the application.

### DESCRIPTION OF EMBODIMENTS

To make the objectives, technical solutions, and advantages of the application clearer, the following further describes the application in detail with reference to the accompanying drawings and embodiments. It should be understood that the specific embodiments described herein are merely used to explain the application but are not intended to limit the application. All other embodiments obtained by a person of ordinary skill in the art based on embodiments of the application without creative efforts shall fall within the protection scope of the application. It should be noted that in the embodiments of the application, descriptions such as “first” and “second” are merely used for description, and shall not be understood as an indication or implication of relative importance or an implicit indication of a quantity of indicated technical features. Therefore, a feature defined by “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

The following provides explanations of terms in the application.

Versatile video coding (VVC) standard: It is a next-generation compression standard for video coding jointly developed by the International Telecommunication Union and the International Organization for Standardization, aiming to to provide higher compression performance and better video quality.

Lookahead precoding: It is a process in which an encoder pre-analyzes a video before encoding starts. It typically refers to the use of an inter-frame prediction technology to reduce an amount of data that needs to be encoded during video encoding. The technology reduces spatial redundancy by predicting a value of a current pixel based on surrounding pixels, to improve encoding efficiency and a compression ratio.

SATD (Sum of Absolute Transformed Differences): It is a metric for measuring a magnitude of a video residual signal. After Hadmard transform is performed on a difference between two pixel matrices, a sum of absolute values of a transform matrix is calculated to evaluate a difference between the two pixel matrices.

Coding Unit (CU): It is a basic unit for encoding processes such as mode prediction, transform, and quantization.

Largest coding unit (LCU): It is a basic unit for image partitioning, and may be further partitioned into CUs of different sizes.

Quantization parameter (QP): It is a parameter used to control a magnitude of distortion in a quantization process. The quantization parameter QP is a sequence number of a quantization step. Therefore, a smaller quantization parameter QP indicates a smaller quantization step, and consequently, a smaller quantization loss, and a lower quantization error, that is, smaller distortion. Conversely, a larger quantization parameter QP indicates a larger quantization step, and consequently, a larger quantization loss, and a higher quantization error, that is, greater distortion.

Quantization group QG): It is a set of coding units that share a same QP.

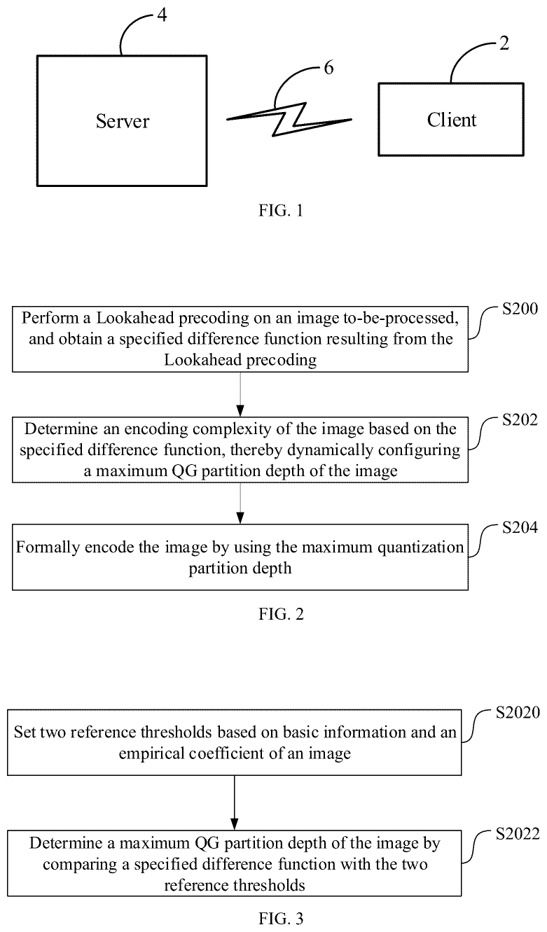

Refer to FIG. 1. FIG. 1 is an architectural diagram of an application environment for implementing embodiments of the application. The application may be applied to an application environment including but not limited to a client 2, a server 4, and a network 6.

The client 2 is configured to display an interface of a current application to a user and receive an operation of the user, such as uploading and selecting a video or an image. The client 2 may be a terminal device such as a PC (Personal Computer), a mobile phone, a tablet computer, a portable computer, or a wearable device.

The server 4 is configured to provide data and technical support for the client 2. The server 4 may be a computing device such as a rack server, a blade server, a tower server, or a cabinet server, or may be a standalone server, or may be a server cluster including a plurality of servers.

The network 6 may be a wireless or wired network, for example, an Intranet, the Internet, a global system for mobile communication (GSM), wideband code division multiple access (WCDMA), a 4G network, a 5G network, Bluetooth, or Wi-Fi. The server 4 is communicatively connected to one or more clients 2 by using the network 6, to perform data transmission and exchange.

### Embodiment 1

FIG. 2 is a flowchart of an image processing method according to Embodiment 1 of the application. It may be understood that the flowchart in the method embodiment is not used to limit a step execution sequence. Some steps may be added to or deleted from the flowchart as required. The method may be performed by the client or the server, which is not limited herein.

The method includes the following steps.

S200: Perform a Lookahead precoding on an image to-be-processed, and obtain a specified difference function resulting from the Lookahead precoding.

In a commonly used hybrid coding framework, each frame of image in a video is first partitioned into fixed-size largest coding units LCUs, and may be further partitioned into variable-size coding units CUs.

The VVC standard supports three different CU partitioning modes: quadtree, binary tree, and ternary tree. In the quadtree partitioning mode, a current CU is equally partitioned into four sub-CUs in horizontal and vertical directions. The binary tree partitioning mode is further divided into two modes: horizontal and vertical, and the current CU is equally partitioned into two sub-CUs in a horizontal or vertical direction. The ternary tree partitioning mode is similar to the binary tree partitioning mode, and is also divided into two modes: horizontal and vertical, but partitioning is performed based on a ratio of 1:2:1. Because multiple partitioning modes are supported, a CU partition depth in the VVC is determined by using an area ratio between partition units. For example, a depth of each sub-CU in the quadtree partitioning mode is equal to a depth of a CU before partitioning plus 2; a depth of each sub-CU in the binary tree partitioning mode is equal to a depth of a CU before partitioning plus 1; and depths of two sub-CUs on two sides in the ternary tree partitioning mode are equal to a depth of a CU before partitioning plus 2, and a depth of a sub-CU in the middle is equal to the depth of the CU before partitioning plus 1.

A modern encoder may further perform a Lookahead precoding process on a video before formal encoding starts. In the process, multiple consecutive images of an input video are buffered to form a raw image queue. In the queue, by traversing combinations of different frame types and reference structures, precoding costs of the combinations are calculated to performe a dynamic frame type decision. In the cost calculation, an image is generally partitioned into fixed-size (for example, an 8×8 size) Lookahead units, simple intra-frame mode prediction and inter-frame mode prediction are performed on each Lookahead unit, and a sum of SATD costs is calculated. Generated coding information is saved to assist a subsequent formal encoding process.

In the embodiment, after the Lookahead precoding is performed on the image, an optimal SATD of each Lookahead unit obtained during the Lookahead precoding of the image is collected, a sum satdSum of optimal SATDs of all Lookahead units in the image is counted, and the satdSum is used as the specified difference function.

S202: Determine an encoding complexity of the image based on the specified difference function, thereby dynamically configuring a maximum QG partition depth of the image.

In the application, after the Lookahead precoding is performed on the image, and before formal encoding starts, the maximum QG partition depth used in image encoding is determined. In the embodiment, the specified difference function is the sum satdSum of the optimal SATDs of the image. When a value of satdSum is larger, it indicates that the encoding complexity of the image is higher, and that a required maximum QG partition depth is also larger.

Specifically, further refer to FIG. 3. FIG. 3 is a schematic diagram of a refined process of step S202. It may be understood that the flowchart is not used to limit a step execution sequence. Some steps may be added to or deleted from the flowchart as required. In the embodiment, step S202 specifically includes:

S2020: Set two reference thresholds based on basic information and an empirical coefficient of the image.

The two reference thresholds are used to determine the encoding complexity of the image, and a first reference threshold is less than a second reference threshold.

Further refer to FIG. 4. FIG. 4 is a schematic diagram of a refined process of step S2020. In the embodiment, step S2020 specifically includes:

S300: Count an average quantization parameter of the image, and obtain an image bit depth and an image size.

The average quantization parameter avgQP of the image may be obtained by means of statistics based on a known QP configuration or calculation results of some algorithms, and details are not described herein. In addition, when the two reference thresholds are set, some basic parameters of the image need to be obtained, including the image bit depth, the image size, and the like.

S302: Set a first empirical coefficient and a second empirical coefficient.

The first empirical coefficient is less than the second empirical coefficient. In the embodiment, after multiple experimental studies, the first empirical coefficient a1 and the second empirical coefficient a2 may be set to 0.4 and 4 respectively.

S304: Set the first reference threshold and the second reference threshold according to a preset formula, based on the first empirical coefficient, the second empirical coefficient, the average quantization parameter, the image bit depth, and the image size.

The first reference threshold is a product of a reference function multiplied by the first empirical coefficient, the second reference threshold is a product of the reference function multiplied by the second empirical coefficient, and the reference function is positively correlated with the average quantization parameter, the image bit depth, and the image size.

Specifically, the first reference threshold Threshold1 and the second reference threshold Threshold2 may be set based on the following formulas:

Threshold1=a1*2\hat{ }(avgQP/6−12+2*(BitDepth−8))*picSize; and

Threshold2=a2*2\hat{ }(avgQP/6−12+2*(BitDepth−8))*picSize, wherein
a1 represents the first empirical coefficient, a2 represents the second empirical coefficient, avgQP represents the average quantization parameter, BitDepth represents the image bit depth, and picSize represents the image size.

Back to S2022 in FIG. 3: Determine the maximum QG partition depth of the image by comparing the specified difference function with the two reference thresholds.

In the embodiment, the maximum QG partition depth is dynamically configured based on a magnitude relationship between satdSum, Threshold1, and Threshold2 of the current image. Specifically, the following three cases are included:
(1) If the specified difference function is less than the first reference threshold, that is, satdSum is less than Threshold1, set the maximum QG partition depth to 0.
(2) If the specified difference function is greater than or equal to the first reference threshold and less than the second reference threshold, that is, satdSum is greater than or equal to Threshold1, and satdSum is less than Threshold2, set the maximum QG partition depth to 2.
(3) If the specified difference function is greater than or equal to the second reference threshold, that is, satdSum is greater than or equal to Threshold2, set the maximum QG partition depth to 4.

In addition, it should be noted that a QG is generally partitioned together with a CU, and that the maximum QG partition depth must not be greater than a maximum CU partition depth. Therefore, if the obtained maximum QG partition depth is greater than the preset maximum CU partition depth, the maximum QG partition depth also needs to be further modified, that is, set to the same value as the maximum CU partition depth.

Back to S204 in FIG. 2: Formally encode the image by using the maximum quantization group partition depth.

In the hybrid coding framework in the application, a predicted image is first obtained for each CU by using an inter-frame or intra-frame prediction technology. A difference between the predicted image and a raw image, also referred to as a residual, is transformed and quantized, and then sent to an entropy encoder for encoding. Then the residual is inverse-quantized and inverse-transformed, and the predicted image is added for reconstruction. Finally, a reconstructed image is obtained through loop filtering. The reconstructed image enters an encoded (reconstructed) image buffer in the encoder as a reference image for inter-frame prediction in subsequent frame encoding.

In the VVC standard, the QG is used as a smallest unit of quantization for encoding. The QG is generally partitioned together with the CU, and the maximum QG partition depth must not be greater than the maximum CU partition depth. When a current partition depth reaches the maximum QG partition depth and is less than the maximum CU partition depth, the QG partitioning is stopped, but the CU may continue to be further partitioned. In the case, one QG covers multiple CUs, and the CUs are encoded by using the same QP. If the CU partitioning is stopped before the maximum QG partition depth is reached, the CU independently becomes a QG.

In the embodiment, the maximum QG partition depth is no longer configured by using a global parameter, but a magnitude of the maximum QG partition depth is dynamically configured after the Lookahead precoding and before the formal encoding of each frame of image starts, and each frame of image of the video is separately encoded by using the dynamically configured maximum QG partition depth.

In another optional embodiment, the method may also be used to adjust other image-level parameters related to image complexity, for example, a maximum CU partition depth for each frame of image. A specific implementation process of the method is similar to the foregoing process, and details are not described herein again.

According to the image processing method provided in the embodiment, coding information generated in the Lookahead precoding process, that is, the sum of SATDs of the image, can be used as a basis for evaluating image encoding complexity, and the maximum QG partition depth for each frame of image in the VVC encoder is dynamically adjusted before the formal encoding starts, to adapt to different video content and encoding parameter conditions, thereby improving video compression efficiency without introducing additional computational overheads.

### Embodiment 2

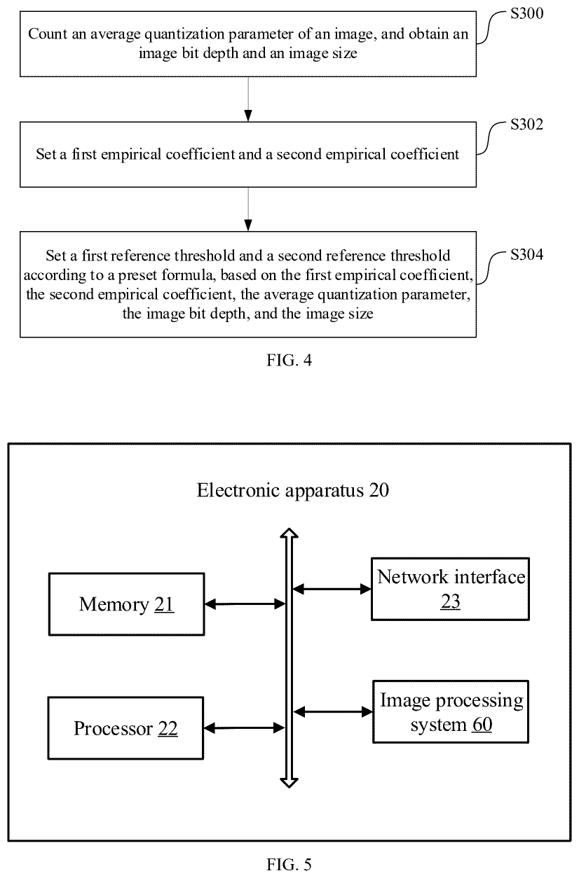

FIG. 5 is a schematic diagram of a hardware architecture of an electronic apparatus 20 according to Embodiment 2 of the application. In the embodiment, the electronic apparatus 20 may include but is not limited to a memory 21, a processor 22, and a network interface 23 that may be communicatively connected to each other by using a system bus. It should be noted that FIG. 5 shows only an electronic apparatus 20 with components 21 to 23. However, it should be understood that implementation of all the shown components is not mandatory, and more or fewer components may alternatively be implemented. In the embodiment, the electronic apparatus 20 may be an apparatus of the client or the server.

The memory 21 includes at least one type of readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 21 may be an internal storage unit of the electronic apparatus 20, for example, a hard disk or a memory of the electronic apparatus 20. In some other embodiments, the memory 21 may be an external storage device of the electronic apparatus 20, for example, a removable hard disk, a smart media card (SMC), a secure digital (SD) card, or a flash card that is disposed on the electronic apparatus 20. Certainly, the memory 21 may include both an internal storage unit of the electronic apparatus 20 and an external storage device of the electronic apparatus 20. In the embodiment, the memory 21 is usually configured to store an operating system and various types of application software that are installed in the electronic apparatus 20, for example, program code of an image processing system 60. In addition, the memory 21 may be further configured to temporarily store various types of data that have been output or are to be output.

The processor 22 may be a central processing unit (CPU), a controller, a microcontroller, a microprocessor, or another data processing chip in some embodiments. The processor 22 is usually configured to control an overall operation of the electronic apparatus 20. In the embodiment, the processor 22 is configured to run the program code stored in the memory 21 or process data, for example, run the image processing system 60.

The network interface 23 may include a wireless network interface or a wired network interface. The network interface 23 is usually configured to establish a communication connection between the electronic apparatus 20 and another electronic device.

### Embodiment 3

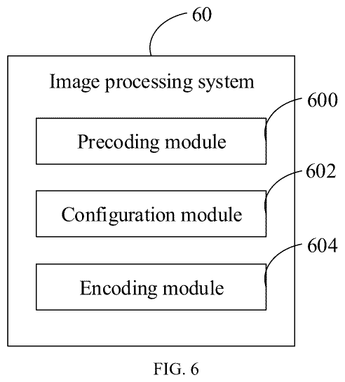

FIG. 6 is a schematic modular diagram of an image processing system 60 according to Embodiment 3 of the application. The image processing system 60 may be divided into one or more program modules. The one or more program modules are stored in a storage medium and executed by one or more processors, to complete the embodiment of the application. The program module in the embodiment of the application is a series of computer program instruction segments that can be used to complete a specified function. The following describes a function of each program module in the embodiment in detail.

In the embodiment, the image processing system 60 includes a precoding module 600, a configuration module 602, and an encoding module 604.

The precoding module 600 is configured to perform a Lookahead precoding on an image to-be-processed, and obtain a specified difference function resulting from the Lookahead precoding.

A modern encoder may perform a Lookahead precoding process on a video before formal encoding starts. In the process, multiple consecutive images of an input video are buffered to form a raw image queue. In the queue, by traversing combinations of different frame types and reference structures, precoding costs of the combinations are calculated to performe a dynamic frame type decision. In the cost calculation, an image is generally partitioned into fixed-size (for example, an 8×8 size) Lookahead units, simple intra-frame mode prediction and inter-frame mode prediction are performed on each Lookahead unit, and a sum of SATD costs is calculated. Generated coding information is saved to assist a subsequent formal encoding process.

In the embodiment, after the Lookahead precoding is performed on the image, an optimal SATD of each Lookahead unit obtained during the Lookahead precoding of the image is collected, a sum satdSum of optimal SATDs of all Lookahead units in the image is counted, and the satdSum is used as the specified difference function.

The configuration module 602 is configured to determine an encoding complexity of the image based on the specified difference function, thereby dynamically configuring a maximum quantization group partition depth of the image.

In the application, after the Lookahead precoding is performed on the image, and before formal encoding starts, the maximum QG partition depth used in image encoding is determined. In the embodiment, the specified difference function is the sum satdSum of the optimal SATDs of the image. When a value of satdSum is larger, it indicates that the encoding complexity of the image is higher, and that a required maximum QG partition depth is also larger.

First, two reference thresholds are set based on basic information and an empirical coefficient of the image. The two reference thresholds are used to determine the encoding complexity of the image, and a first reference threshold is less than a second reference threshold.

The first reference threshold and the second reference threshold are set according to a preset formula, based on a first empirical coefficient, a second empirical coefficient, an average quantization parameter of the image, an image bit depth, and an image size. The first reference threshold is a product of a reference function multiplied by the first empirical coefficient, the second reference threshold is a product of the reference function multiplied by the second empirical coefficient, and the reference function is positively correlated with the average quantization parameter, the image bit depth, and the image size.

Specifically, the first reference threshold Threshold1 and the second reference threshold Threshold2 may be set based on the following formulas:

Threshold1=a1*2\hat{ }(avgQP/6−12+2*(BitDepth−8))*picSize; and

Threshold2=a2*2\hat{ }(avgQP/6−12+2*(BitDepth−8))*picSize, wherein
a1 represents the first empirical coefficient, a2 represents the second empirical coefficient, avgQP represents the average quantization parameter, BitDepth represents the image bit depth, and picSize represents the image size.

Then the maximum QG partition depth of the image is determined by comparing the specified difference function with the two reference thresholds.

In the embodiment, the maximum QG partition depth is dynamically configured based on a magnitude relationship between satdSum, Threshold1, and Threshold2 of the current image. Specifically, the following three cases are included:
(1) If the specified difference function is less than the first reference threshold, that is, satdSum is less than Threshold1, set the maximum QG partition depth to 0.
(2) If the specified difference function is greater than or equal to the first reference threshold and less than the second reference threshold, that is, satdSum is greater than or equal to Threshold1, and satdSum is less than Threshold2, set the maximum QG partition depth to 2.
(3) If the specified difference function is greater than or equal to the second reference threshold, that is, satdSum is greater than or equal to Threshold2, set the maximum QG partition depth to 4.

In addition, it should be noted that a QG is generally partitioned together with a CU, and that the maximum QG partition depth must not be greater than a maximum CU partition depth. Therefore, if the obtained maximum QG partition depth is greater than the preset maximum CU partition depth, the maximum QG partition depth also needs to be further modified, that is, set to the same value as the maximum CU partition depth.

The encoding module 604 is configured to formally encode the image by using the maximum quantization group partition depth.

In the hybrid coding framework in the application, a predicted image is first obtained for each CU by using an inter-frame or intra-frame prediction technology. A difference between the predicted image and a raw image, also referred to as a residual, is transformed and quantized, and then sent to an entropy encoder for encoding. Then the residual is inverse-quantized and inverse-transformed, and the predicted image is added for reconstruction. Finally, a reconstructed image is obtained through loop filtering. The reconstructed image enters an encoded (reconstructed) image buffer in the encoder as a reference image for inter-frame prediction in subsequent frame encoding.

In the VVC standard, the QG is used as a smallest unit of quantization for encoding. The QG is generally partitioned together with the CU, and the maximum QG partition depth must not be greater than the maximum CU partition depth. When a current partition depth reaches the maximum QG partition depth and is less than the maximum CU partition depth, the QG partitioning is stopped, but the CU may continue to be further partitioned. In the case, one QG covers multiple CUs, and the CUs are encoded by using the same QP. If the CU partitioning is stopped before the maximum QG partition depth is reached, the CU independently becomes a QG.

In the embodiment, the maximum QG partition depth is no longer configured by using a global parameter, but a magnitude of the maximum QG partition depth is dynamically configured after the Lookahead precoding and before the formal encoding of each frame of image starts, and each frame of image of the video is separately encoded by using the dynamically configured maximum QG partition depth.

According to the image processing system provided in the embodiment, coding information generated in the Lookahead precoding process, that is, the sum of SATDs of the image, can be used as a basis for evaluating image encoding complexity, and the maximum QG partition depth for each frame of image in the VVC encoder is dynamically adjusted before the formal encoding starts, to adapt to different video content and encoding parameter conditions, thereby improving video compression efficiency without introducing additional computational overheads.

### Embodiment 4

The application further provides another implementation, that is, provides a computer-readable storage medium. The computer-readable storage medium stores an image processing program. The image processing program may be executed by at least one processor, so that the at least one processor performs the steps of the image processing method.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, for example, program code of the image processing method in the embodiments. In addition, the computer-readable storage medium may be further configured to temporarily store various types of data that have been output or are to be output.

### Embodiment 5

The application further provides a computer program product. The computer program product includes an image processing program. The image processing program may be executed by at least one processor, so that the at least one processor performs the steps of the foregoing image processing method.

It should be noted that in the specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element.

The sequence numbers of the foregoing embodiments of the application are merely for description, and are not intended to indicate priorities of the embodiments.

Clearly, a person skilled in the art should understand that the foregoing modules or steps in the embodiments of the application may be implemented by using a general computing apparatus.

The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in an order different from the order herein. Alternatively, the modules or steps are separately made into integrated circuit modules, or a plurality of modules or steps in the modules or steps are made into a single integrated circuit module for implementation. In this way, a combination of any specific hardware and software is not limited in the embodiments of the application.

The foregoing descriptions are merely preferred embodiments in the embodiments of the application, and are not intended to limit the scope of the embodiments of the application. Any equivalent structure or equivalent procedure change made by using the content of the specification and the accompanying drawings of the embodiments of the application, or any direct or indirect application in other related technical fields shall fall within the protection scope of the embodiments of the application.

What is claimed is:

1. An image processing method, wherein the method comprises:
performing a Lookahead precoding on an image to-be-processed, and obtaining a specified difference function resulting from the Lookahead precoding;
determining an encoding complexity of the image based on the specified difference function, thereby dynamically configuring a maximum quantization group partition depth of the image; and
formally encoding the image by using the maximum quantization group partition depth.

2. The image processing method according to claim 1, wherein the obtaining a specified difference function resulting from the precoding comprises:
collecting an optimal SATD of each Lookahead unit obtained during the Lookahead precoding of the image; and
counting a sum of optimal SATDs of all Lookahead units in the image as the specified difference function.

3. The image processing method according to claim 1, wherein the determining an encoding complexity of the image based on the specified difference function, thereby dynamically configuring a maximum quantization group partition depth of the image comprises:
setting two reference thresholds based on basic information and an empirical coefficient of the image, wherein a first reference threshold is less than a second reference threshold; and
determining the maximum quantization group partition depth of the image by comparing the specified difference function with the two reference thresholds.

4. The image processing method according to claim 3, wherein the setting two reference thresholds based on basic information and an empirical coefficient of the image comprises:
counting an average quantization parameter of the image, and obtaining an image bit depth and an image size;
setting a first empirical coefficient and a second empirical coefficient, wherein the first empirical coefficient is less than the second empirical coefficient; and
setting the first reference threshold and the second reference threshold according to a preset formula, based on the first empirical coefficient, the second empirical coefficient, the average quantization parameter, the image bit depth, and the image size, wherein the first reference threshold is a product of a reference function multiplied by the first empirical coefficient, the second reference threshold is a product of the reference function multiplied by the second empirical coefficient, and the reference function is positively correlated with the average quantization parameter, the image bit depth, and the image size.

5. The image processing method according to claim 3, wherein
the first reference threshold is: Threshold1=a1*2\hat{ }(avgQP/6−12+2*(BitDepth−8))*picSize; and
the second reference threshold is: Threshold2=a2*2\hat{ }(avgQP/6−12+2*(BitDepth−8))*picSize, wherein
a1 represents the first empirical coefficient, a2 represents the second empirical coefficient, avgQP represents the average quantization parameter, BitDepth represents the image bit depth, and picSize represents the image size.

6. The image processing method according to claim 3, wherein the determining the maximum quantization group partition depth of the image by comparing the specified difference function with the two reference thresholds comprises:
when the specified difference function is less than the first reference threshold, setting the maximum quantization group partition depth of the image to 0.

7. The image processing method according to claim 6, wherein the determining the maximum quantization group partition depth of the image by comparing the specified difference function with the two reference thresholds further comprises:
when the specified difference function is greater than or equal to the first reference threshold and less than the second reference threshold, setting the maximum quantization group partition depth of the image to 2.

8. The image processing method according to claim 7, wherein the determining the maximum quantization group partition depth of the image by comparing the specified difference function with the two reference thresholds further comprises:
when the specified difference function is greater than or equal to the second reference threshold, setting the maximum quantization group partition depth of the image to 4.

9. The image processing method according to claim 6, wherein the determining the maximum quantization group partition depth of the image by comparing the specified difference function with the two reference thresholds further comprises:
when the obtained maximum quantization group partition depth is greater than a preset maximum coding unit partition depth, modifying the maximum quantization group partition depth to the preset maximum coding unit partition depth.

10. An image processing system, wherein the system comprises:
a precoding module, configured to perform a Lookahead precoding on an image to-be-processed, and obtain a specified difference function resulting from the Lookahead precoding;
a configuration module, configured to determine encoding complexity of the image based on the specified difference function, thereby dynamically configuring a maximum quantization group partition depth of the image; and
an encoding module, configured to formally encode the image by using the maximum quantization group partition depth.

11. An electronic apparatus, wherein the electronic apparatus comprises a memory, a processor, and a computer program stored in the memory and capable of running on the processor, and the computer program, when executed by the processor, causes the processor to implement operations comprising:
performing a Lookahead precoding on an image to-be-processed, and obtaining a specified difference function resulting from the Lookahead precoding;
determining an encoding complexity of the image based on the specified difference function, thereby dynamically configuring a maximum quantization group partition depth of the image; and
formally encoding the image by using the maximum quantization group partition depth.

12. The electronic apparatus according to claim 11, wherein the obtaining a specified difference function resulting from the precoding comprises:
collecting an optimal SATD of each Lookahead unit obtained during the Lookahead precoding of the image; and
counting a sum of optimal SATDs of all Lookahead units in the image as the specified difference function.

13. The electronic apparatus according to claim 11, wherein the determining an encoding complexity of the image based on the specified difference function, thereby dynamically configuring a maximum quantization group partition depth of the image comprises:
setting two reference thresholds based on basic information and an empirical coefficient of the image, wherein a first reference threshold is less than a second reference threshold; and
determining the maximum quantization group partition depth of the image by comparing the specified difference function with the two reference thresholds.

14. The electronic apparatus according to claim 13, wherein the setting two reference thresholds based on basic information and an empirical coefficient of the image comprises:
counting an average quantization parameter of the image, and obtaining an image bit depth and an image size;
setting a first empirical coefficient and a second empirical coefficient, wherein the first empirical coefficient is less than the second empirical coefficient; and
setting the first reference threshold and the second reference threshold according to a preset formula, based on the first empirical coefficient, the second empirical coefficient, the average quantization parameter, the image bit depth, and the image size, wherein the first reference threshold is a product of a reference function multiplied by the first empirical coefficient, the second reference threshold is a product of the reference function multiplied by the second empirical coefficient, and the reference function is positively correlated with the average quantization parameter, the image bit depth, and the image size.

15. The electronic apparatus according to claim 13, wherein
the first reference threshold is: Threshold1=a1*2\hat{ }(avgQP/6−12+2*(BitDepth−8))*picSize; and
the second reference threshold is: Threshold2=a2*2\hat{ }(avgQP/6−12+2*(BitDepth−8))*picSize, wherein
a1 represents the first empirical coefficient, a2 represents the second empirical coefficient, avgQP represents the average quantization parameter, BitDepth represents the image bit depth, and picSize represents the image size.

16. The electronic apparatus according to claim 13, wherein the determining the maximum quantization group partition depth of the image by comparing the specified difference function with the two reference thresholds comprises:
when the specified difference function is less than the first reference threshold, setting the maximum quantization group partition depth of the image to 0.

17. The electronic apparatus according to claim 16, wherein the determining the maximum quantization group partition depth of the image by comparing the specified difference function with the two reference thresholds further comprises:
when the specified difference function is greater than or equal to the first reference threshold and less than the second reference threshold, setting the maximum quantization group partition depth of the image to 2.

18. The electronic apparatus according to claim 17, wherein the determining the maximum quantization group partition depth of the image by comparing the specified difference function with the two reference thresholds further comprises:
when the specified difference function is greater than or equal to the second reference threshold, setting the maximum quantization group partition depth of the image to 4.

19. A non-transitory computer-readable storage medium, wherein the computer-readable storage medium stores an image processing program, and when the image processing program is executed by a processor, the image processing method according to claim 1 is implemented.

20. A computer program product, wherein the computer program product comprises an image processing program, and when the image processing program is executed by a processor, the image processing method according to claim 1 is implemented.
